(19) United States
(12) Patent Application Publication
(10) Pub. No.: US 2026/0301518 A1
(43) Pub. Date: Oct. 1, 2026

(54) Product Fingerprinting for Data Merging and Identification Across Multiple Platforms

(71) Applicant: Aristocrat Technologies, Inc., Las Vegas, NV (US)

(72) Inventors: Upinder Dhaliwal, Las Vegas, NV (US); Eric Droukas, Las Vegas, NV (US)

(21) Appl. No.: 19/316,527

(22) Filed: Sep. 2, 2025

Related U.S. Application Data
(60) Provisional application No. 63/779,859, filed on Mar. 28, 2025.

(51) Int. Cl. G07F 17/32; G06F 3/0482

(52) U.S. Cl. CPC G07F 17/3227; G06F 3/0482

(57) ABSTRACT

Techniques for product fingerprinting are described. The technique involves receiving a request for gaming data from an operator device, identifying configuration parameters based on the request, and determining operator characteristics. The technique also involves identifying one or more operator characteristics from the operator device, and determining one or more second configuration parameters associated with the operator characteristics. Electronic gaming machine records are retrieved from a gaming data store based on records having a configuration identifier comprising the one or more first configuration parameters and the one or more second configuration parameters.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Typically, multiple EGMs of different types and/or that implement different games are disposed on a gaming area managed for example by a casino operator, and the casino operator selects the EGMs, the games that are implemented and the locations of the EGMs on the gaming area according to defined criteria.

### SUMMARY

A system of one or more computers can be configured to perform particular operations or actions by virtue of having software, firmware, hardware, or a combination of them installed on the system that in operation causes or cause the system to perform the actions. One general aspect includes a method of receiving, from an operator device, a request for gaming data corresponding to a first gaming machine configuration at a gaming location associated with an operator. The method also includes identifying one or more first configuration parameters based on the request. The method also includes identifying one or more operator characteristics from the operator device. The method also includes determining one or more second configuration parameters associated with the operator characteristics. The method also includes retrieving, from a gaming data store at a content management system, one or more electronic gaming machine records having a configuration identifier may include the one or more first configuration parameters and the one or more second configuration parameters. The method also includes obtaining the gaming data based on the one or more electronic gaming machine records. Other embodiments of this aspect include corresponding computer systems, apparatus, and computer programs recorded on one or more computer storage devices, each configured to perform the actions of the methods.

According to one or more embodiments, the method may also include providing the gaming data to the operator device. The request for gaming data may include a request to transition a preexisting cabinet at the gaming location, and where the one or more first gaming parameters may include an identifier for the preexisting cabinet. The method may also include receiving an updated electronic gaming machine record having a first configuration identifier, performing a matching process between the first configuration identifier and a set of currently stored configuration identifiers, and in response to determining that the first configuration identifier fails to match any currently stored configuration identifier, generating a new asset in the gaming data store corresponding to the updated electronic gaming machine. Performing a matching process between the first configuration identifier and a set of currently stored configuration identifiers may include parsing the first configuration identifier into a set of first identifier parameters each associated with a different parameter type of a set of hierarchical parameters, and performing the matching process between each of the first identifier parameters in accordance with a set of tiers of the hierarchical parameters. The method may include generating the new asset by branching a prior asset based on a hierarchical tier at which the first configuration identifier failed to match any currently stored configuration identifier. The one or more first gaming parameters may include one or more identifiers for an electronic gaming machine characteristic, and where the one or more second gaming parameters may include one or more identifiers for a jurisdictional limitation for the gaming location.

Implementations of the described techniques may include hardware, a method or process, or computer software on a computer-accessible medium.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3. depicts an example network diagram in which one or more embodiments are performed.

FIG. 4 is a block diagram of an exemplary network diagram for a particular operator and/or gaming location, in accordance with one or more embodiments.

FIGS. 5A-5B depict example uses of a UPID, in accordance with one or more embodiments.

FIG. 6 is a flow chart of a technique for using UPIDs to access gaming configuration data, in accordance with one or more embodiments.

FIG. 7 is a flow chart for providing conversion options, according to one or more embodiments.

FIG. 8 depicts a flowchart of a technique for updating gaming data, according to one or more embodiments of the disclosure.

FIG. 9 depicts a flowchart of a process for merging analytic data according to one or more embodiments of the disclosure.

### DETAILED DESCRIPTION

The disclosure describes creating a unique product identifier that attaches to game data information stored on the content management system (CMS). The CMS integrates and communicates with one or more independent and separate systems to obtain additional game data and/or casino operator information. The CMS combines locally stored gaming information, and other gaming and casino operator information received from the independent system(s) based on the unique product identifier. By doing so, the CMS can now provide casino operators customized, specific, and relevant information.

The present disclosure relates to a system and method for creating a unique product identifier (UPID) that integrates game data from multiple sources to provide customized information to casino operators. The UPID may be a parseable identifier from which different categories of configuration parameters can be identified. For example, the UPID may include a concatenation of different identifiers for various game parameters, such as game title, game family, cabinet type, class type, commercial type, and jurisdiction. The UPID allows the system to link and merge game data from different data sources, such as a CMS, a game analytics system, a casino management device, a data collection system, an operator device, or the like. The system can use the UPID to retrieve relevant information for a particular query, link data to particular configurations, or the like.

According to one or more embodiments, a technical problem exists because a CMS may not have access to information specific to a particular operator or gaming location, in order to provide customized gaming data. As a result, the CMS must obtain and consolidate gaming information from multiple sources, which can result in retrieving data in multiple formats, leading to a challenge in consolidating and performing automated processes on the combined set of data. That is, even if the CMS can obtain such additional product and casino information, the CMS lacks a method to convert and combine similar product and casino information obtained from a variety of data sources.

The technical solution involves creating a unique product identifier (UPID) that acts as a product fingerprint. The UPID may include parseable segments, where different segments of the product identifier are based on different configuration parameters related to the game, the physical cabinet on which the game is performed, as well as jurisdictional and other data relevant to the limitations of certain operators and/or gaming locations. Specifically, the UPID is constructed by combining a title identifier, family identifier, cabinet identifier, class identifier, and commercial identifier.

With respect to the CMS accessing relevant gaming records, the CMS may receive, from an operator device, a request for gaming data corresponding to a first gaming machine configuration at a gaming location associated with an operator. The CMS may identify one or more first configuration parameters based on the request. The CMS may further identify one or more operator characteristics from the operator device and determine one or more second configuration parameters associated with the operator characteristics. The CMS may then retrieve, from a gaming data store, one or more electronic gaming machine records having a configuration identifier comprising the one or more first configuration parameters and the one or more second configuration parameters, and obtain the gaming data based on the one or more electronic gaming machine records.

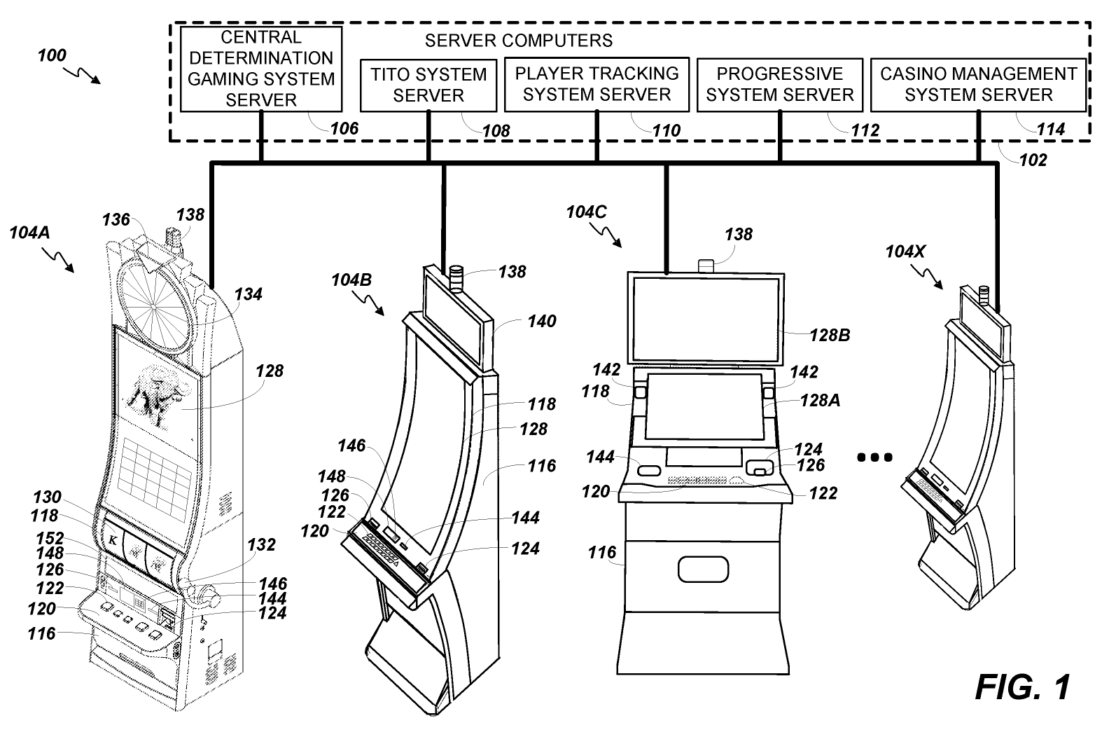

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (Wi-Fi^{®}) and Bluetooth^{®}), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL^{TM} model gaming device manufactured by Aristocrat^{®} Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino-issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique barcodes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

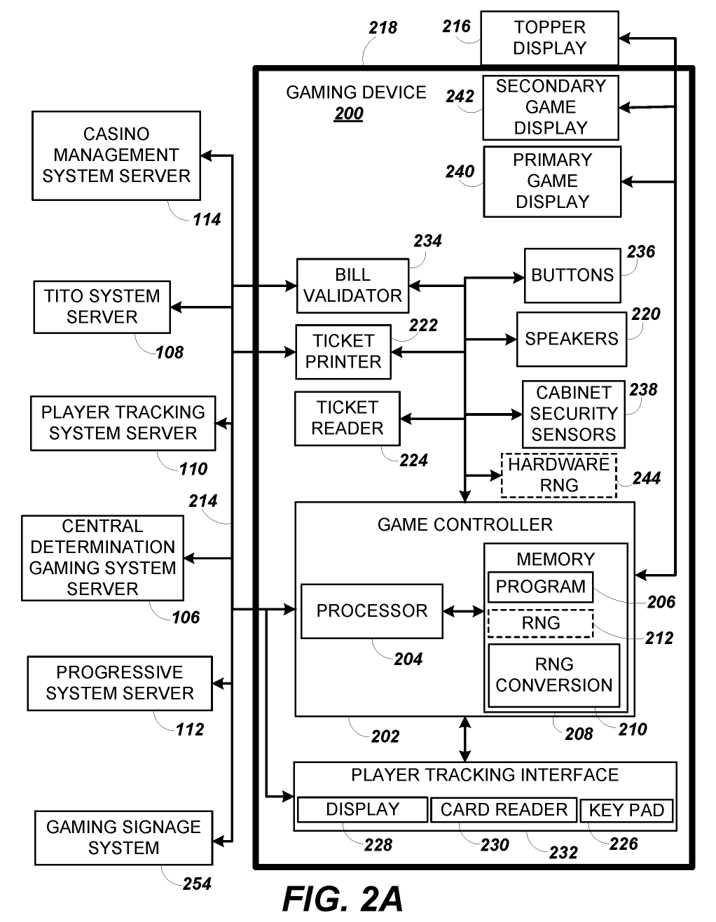

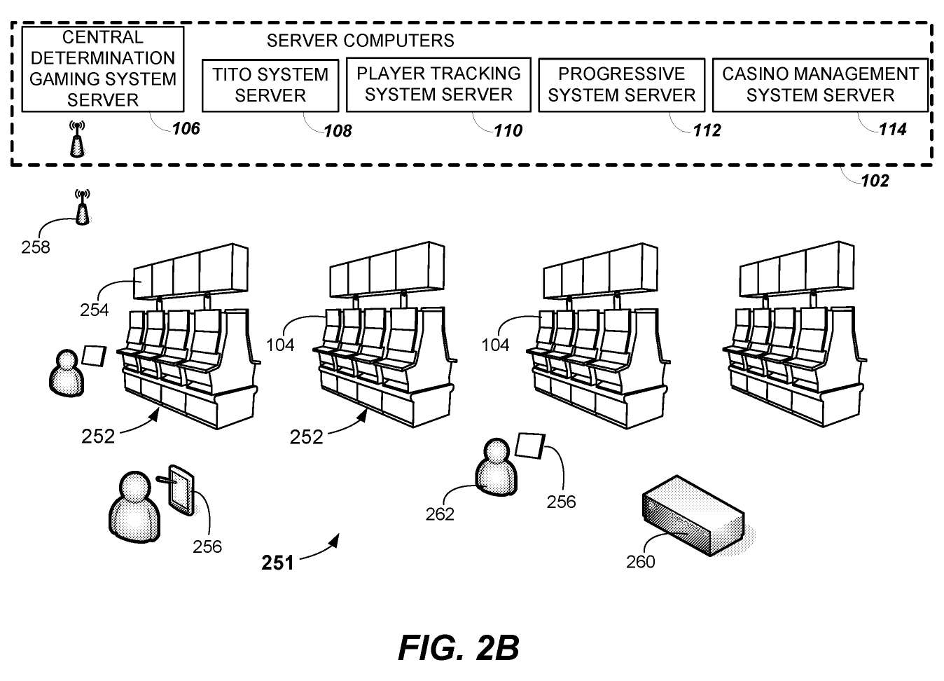

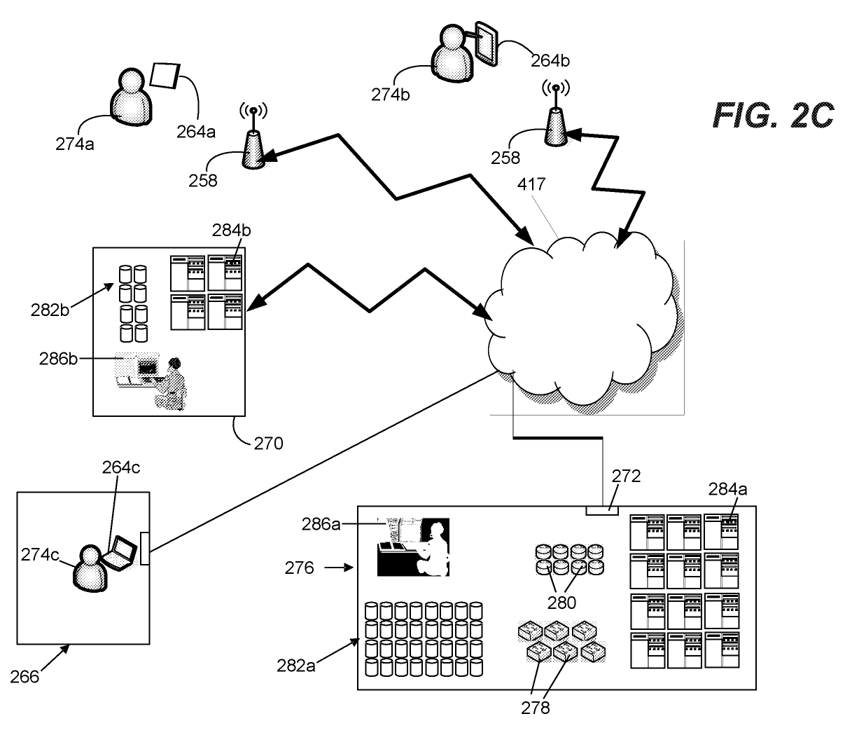

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc^{TM} model gaming device manufactured by Aristocrat^{®} Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify, and/or upgrade the software, and for general maintenance operations.

Another example gaming device 104C shown is the Helix^{TM} model gaming device manufactured by Aristocrat^{®} Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints barcoded tickets or other media or mechanisms for storing or indicating a player’s credit value, a ticket reader 224 which reads barcoded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that does not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS^{®} system manufactured by Aristocrat^{®} Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment, and/or additional play. Player tracking information may be combined with other information that is now readily obtainable by a casino management device.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs the game outcome on one or more of the primary game display(s) 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during the course of game play (such as spinning a wheel to begin a bonus round or selecting various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth^{®} or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., Wi-Fi^{®} or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones, and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player’s EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

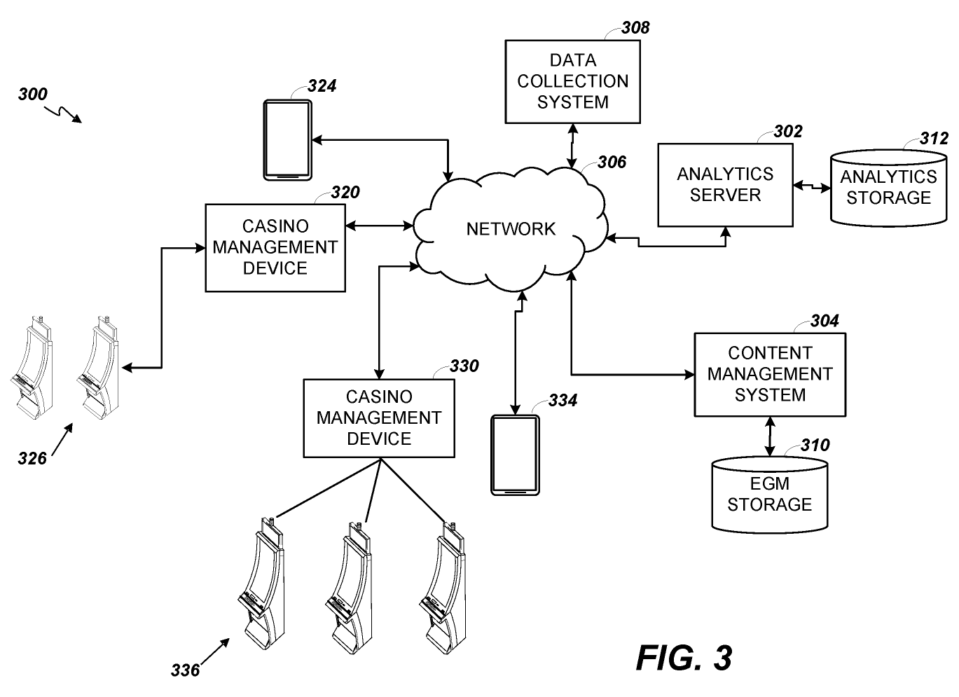

Turning to FIG. 3, a network diagram 300 is presented in which various embodiments described herein are performed, in accordance with one or more embodiments. The network diagram includes gaming devices at multiple gaming locations. For example, casino management device 320 may provide functionality for land-based gaming in an ecosystem corresponding to the electronic gaming machines 326, which may be different than the ecosystem supported by casino management device 330, which includes electronic gaming machines 336. In some embodiments, the casino management device 320 and the casino management device 330 may communicably connect to other devices across network 306. Network 306 may include one or more different types of networks, such as the Internet, a local area network (LAN), a wide area network (WAN), or a wireless network.

According to one or more embodiments, different ecosystems may be located in different locations which may have unique laws and regulations regarding gameplay. In addition, the different ecosystems may be operated by different operators. To that end, a user associated with an operator may access data related to their corresponding ecosystem via the local casino management system. In some embodiments, the operator may access the data by an application at an electronic device, such as operator device 324, and operator device 334. In some embodiments, operator device 324 may communicably connect to casino management device 320, whereas operator device 334 may communicably connect to casino management device 330. According to one or more embodiments, each of operator device 324 and operator device 334 may be client devices, such as smartphones, tablets, laptops, desktop computers, mobile devices, or the like, that are configured to run an electronic gaming machine (EGM) management application. The EGM management application allows casino operators to access and manage game data from the casino management device, the game analytics system, the content management system, and/or other network devices.

The content management system (CMS) 304, is a system that stores and manages game data for various games, such as game titles, game families, game features, game assets, game configurations, game availability, and game release dates. According to one or more embodiments, the CMS may manage gaming data using unique product identifiers (UPIDs), which are assigned using an automated system to uniquely identify gaming configurations, including game titles and other software-based gaming data, cabinets or other devices on which the gaming data is executed, a classification of the game, and the like. Further, the UPID may encode other data that causes a particular EGM configuration to be unique, such as a jurisdiction of the EGM or other limitations. The UPID may then be used to store and/or manage other information about the particular configuration identified by the UPID.

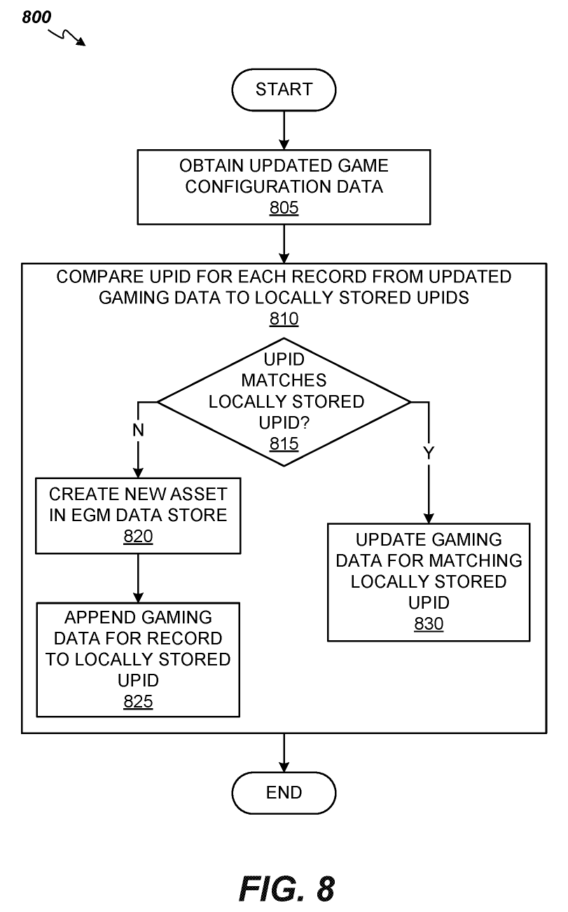

According to one or more embodiments, the UPID may be generated the CMS 304 for numerous games and jurisdictions. The CMS may include, for example, one or more content servers, and EGM storage 310. The gaming system may be accessed by one or more client devices through a user interface to manage data about the EGMs. The CMS 304 may occasionally or periodically receive updated gaming data, for example from a user device, an analytics sever 302, data collection system 308, or the like. The CMS may then update gaming data, for example in EGM storage 310, based on the UPIDs associated with the updated gaming data records, as will be described in greater detail below with respect to FIG. 8.

The CMS may also use the UPIDs to link and merge game data from different data sources. In some embodiments, game data may be received from a game analytics system, which may include, for example, analytics sever 302, and/or analytics storage 312. The game analytics system is a system that collects and analyzes game performance data for various games, such as game revenue, game utilization, game popularity, game volatility, game hold percentage, and game player demographics. The game analytics server 302 may assign UPIDs, or other identifiers, to the game performance data based on the game parameters.

The network diagram 300 includes a data collection system 308, in which gaming data related to electronic games, gaming devices such as cabinets, operators, or the like may be stored. Data collection system 308 may include storage devices and/or computing devices from which data collection processes can be performed. The data collection system 308 is a system that collects and stores data from various sources, such as EGMs, gaming servers, operator devices, casino management systems, and the like. The data collection system 308 collects and stores data such as EGM configuration data, EGM performance data, EGM event data, EGM security data, EGM location data, EGM serial number data, gaming server data, gaming signage data, and operator device data. The data collection system 308 communicates with the CMS, the game analytics system, and the casino management system to provide data to these systems.

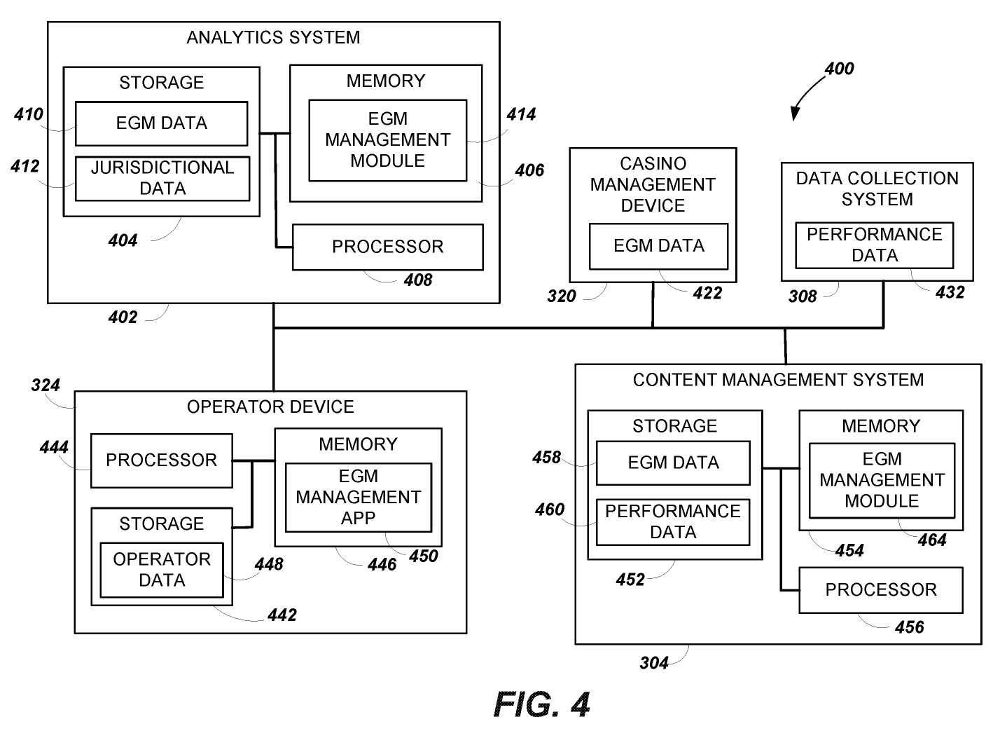

FIG. 4 is a block diagram of an exemplary network diagram for a particular operator and/or gaming location, in accordance with one or more embodiments. In particular, network diagram includes CMS 304 and operator device 324 associated with a particular gaming location, such as a particular casino. Network diagram 400 additionally includes other network devices accessible across a network, such as analytics system 402, gaming system 420, and data collection system 308.

The operator device 324 runs an EGM management application 450, from which an operator can view and/or manage information about gaming devices in the gaming location, according to one or more embodiments of the disclosure. Casino management device 320 stores and manages game data for various games. The operator device 324 may be an electronic device that includes a processor 444, a memory 446, a storage 442, and other components not shown to facilitate operator management of gaming data. For example, the operator device may additionally include a display, an input device, a network interface, a speaker, and the like. The processor 444 is configured to execute instructions stored in the memory 406 or the storage 442 to perform various functions and operations of the operator device 324. Processor 444 represents a general-purpose processor, a specialized processor intended to perform certain functional tasks, or a combination thereof. As an example, processor 444 can be a central processing unit (CPU) that has one or more multi-core processing units and memory mediums (e.g., cache memory) that function as buffers and/or temporary storage for data. Alternatively, processor 444 can be a specialized processor, such as an application specific integrated circuit (ASIC), graphics processing unit (GPU), field-programmable gate array (FPGA), digital signal processor (DSP), or another type of hardware accelerator. In another example, processor 444 is a system on chip (SoC) that combines and integrates one or more general-purpose processors and/or one or more specialized processors.

The memory 446 may be a volatile or non-volatile memory. Examples of memory 446 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 4 illustrates that operator device 324 includes a single memory 446, operator device 324 could include multiple memories 446 for storing program instructions and/or data.

As shown, memory 446 may include an EGM management application 450. The EGM management application may provide an interface for an operator to review and manage electronic gaming machines within the gaming location. In some embodiments, the EGM management application 450 may interface with other systems, such as CMS 304, to provide services related to management of the data related to configuration and performance of the EGMs, such as providing analytics, previewing available new products, or the like. In some embodiments, operator device 324 may provide a request for gaming data to the CMS 304, along with information relevant to the request, such as operator data 448 from storage 442. Operator data may provide characteristics about the gaming location and/or operator which are germane to identifying relevant gaming data. This may include, for example, jurisdiction of the operator and/or gaming location, allowable or preferred class types, or other limitations or preferences for the operator and/or gaming location. Such operator data may be stored, for example in operator data 448 of storage 442.

CMS 304 may include, for example, a memory 454, storage 452, and processor 456. Memory 454 and storage 452 may each include one or more memory or storage types. Examples of memory 454 and storage 452 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components.

Memory 454 may include an EGM management module 464, which includes computer readable code executable by processor 456 to perform processes related to collecting and managing game data, machine data, and the like. In addition, EGM management module 464 may provide services for EGM management application 450 related to management of gaming devices. For example, storage 452 may store EGM data 458 related to current EGMs in operation and, optionally, additional potential EGM configurations for the operator. The EGM data 458 may be stored in relation to UPIDs for the particular gaming configurations. In some embodiments, EGM management module 464 may also determine performance data for EGMs for the operator. Performance data 460 is stored in storage 452. EGM management module 464 may additionally interface with other devices in order to retrieve other performance data. The additional performance data may be compared against local data by determining relevant data from the performance data based on a UPID that is either provided with the data or determined by the EGM management module 464 based on a source of the data. In doing so, EGM management module 464 may provide analytics data for operator device 324.

According to one or more embodiments, EGM management module 464 may interface with other devices across a network to receive updated gaming data. The updated gaming data may be received as a set of records each corresponding to a UPID. The EGM management module 464 may perform a matching process between the new gaming data and the prior stored gaming data in EGM data 458 in order to update EGM data 458 based on the updated records.

According to one or more embodiments, UPIDs may be assigned at CMS 304, and/or at a remote location, such as analytics system 402. The analytics system may include a memory 406, storage 404, and processor 408. Memory 406 and storage 404 may each include one or more memory or storage types. Examples of memory 406 and storage 404 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components.

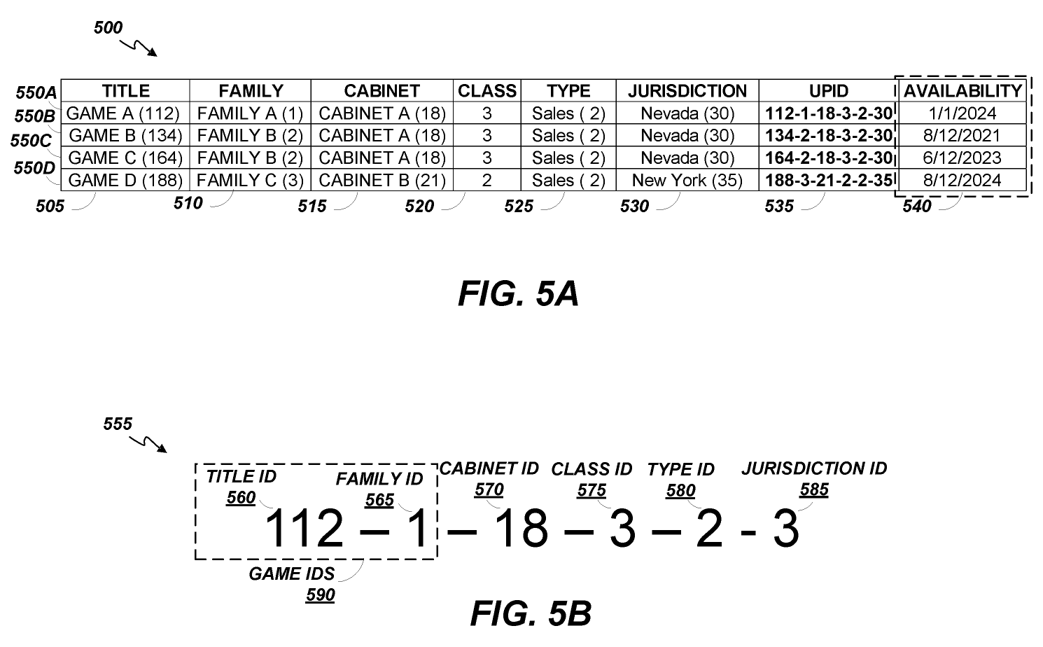

Memory 406 may include an EGM management module 414, which includes computer readable code executable by processor 408 to perform processes related to collecting, managing, and analyzing game performance data from various versions of EGMs, such as game revenue, game utilization, game popularity, game volatility, game hold percentage, and game player demographics. In some embodiments, the analytics system 402 creates and assigns UPIDs to the game performance data based on game parameters and communicates with the CMS to provide these UPIDs and performance data. Accordingly, the global set of UPIDs may include all potential gaming device configurations. As will be described in greater detail below with respect to FIG. 5, a UPID may be an EGM configuration identifier that identifies software, hardware, and jurisdiction as a set of parameters which may be concatenated to form the UPID. These UPIDs may then be used to store gaming data related to EGMs that are characterized not only by their game title and cabinet, but also the jurisdiction for the particular configuration and/or other configuration parameters, such as game class or the like. Storage 404 may include data for use in determining analytics, such as EGM data 410, and jurisdictional data 412.

The data collection system 308 gathers data from multiple sources, such as from multiple casino management devices from multiple gaming locations. The data collection system 308 may collect performance data 432, as well as other types of data, such as EGM configuration data, event data, security data, location data, and the like. The data collection system 308 may communicate with the CMS 304, the analytics system 402, and/or the casino management device 320 to provide gaming data which may not be available from other sources.

An example record of gaming data is shown in FIG. 5A. As shown in record store 500, each record has a unique UPID that distinguishes it from other configurations based on the parameters such as game parameters, jurisdiction parameters, cabinet parameters, and the like. The particular parameters disclosed in FIGS. 5A-5B are meant for example purposes only, and are not intended to limit the specific parameters used for the UPID. In the example shown, parameters for the UPID include title identifier 505, identifying a particular game title and family identifier 510, identifying a game family to which the game title belongs. The UPID may include parameters to specify different configurations of games, both from a hardware and software perspective, and other characteristics affecting access to or availability of a particular configuration. The example UPID also includes a cabinet identifier 515, which indicates the cabinet onto which the game is loaded. The parameters also include a class identifier 520, identifying game a game class, a type identifier 525 identifying a commercial parameter, such as whether the configuration is provided by sale or lease, and jurisdiction identifier 530, indicating the jurisdiction for the configuration identified in the record. According to one or more embodiments, the UPID is created by concatenating a set of configuration parameter values, such as title identifier 505, family identifier 510, cabinet identifier, class identifier 520, type identifier 525, jurisdiction identifier 530, or the like.

Record store 500 is depicted as a data structure that includes information that comprises the specific configuration and data about that configuration. For example, record 550A is associated with Game A, which has a title identifier of 112, and belongs to a gaming family with an identifier of 1. The particular configuration for record 550A is associated with Cabinet A, which is associated with an identifier of 18. Game A is a class 3 game, and a sales type associated with an identifier of 2, and has a sales type, with an identifier of 2. The configuration of record 550A is associated with a Nevada jurisdiction, having an identifier of 30. Accordingly, the configuration described in record 550A has a UPID of 112-1-18-3-2-30.

Turning to FIG. 5B, an example UPID 555 from record 550A of FIG. 5A. The UPID 555 includes a set of parameter values associated with configuration characteristics. The UPID 555 includes parameters associated with game identifiers 590. This includes a title identifier value 560 (112) and a family identifier value 565 (1). The UPID 555 includes a cabinet identifier value 570 (18), and a class identifier value 575 (3). The UPID 555 also includes a type identifier value 580 (2) and a jurisdiction identifier value 585 (3). The UPID 555 is made up of a combination of the different values in a format that allows for different components, such as parameter values, to be identified. In this example, the different parameter values are separated by dashes such that the UPID can be automatically interpreted by a computing device. In some embodiments, at least some of the different parameters may be part of a hierarchical set of values. For example, a family identifier may be associated with multiple title identifiers, and a cabinet identifier may be associated with multiple family identifiers.

Returning to FIG. 5A, each record is stored in the record store 500 with a unique UPID. For example, record 550B has a UPID of 134-2-18-3-2-30. By comparing the UPIDs of records 550A and 550B, it is clear that they are associated with a common cabinet, class, type, and jurisdiction, but have different titles and game families. Similarly, record 550C has a UPID of 164-2-18-3-2-30, showing a common game family and cabinet as record 550B, but a different game title. Record 550D is associated with a UPID of 188-3-21-2-2-35, showing a cabinet in a different jurisdiction, New York, which is associated with the identifier, “35.”

According to one or more embodiments, the UPIDs may be used to manage data associated with different gaming configurations. For example, data store 500 includes gaming data such as availability data 540. In some embodiments, the availability data may indicate a release date for the particular configuration. This is notable because the release date may not be associated with just a game or cabinet, but may be determined based on regulatory guidelines or other rulesets based on jurisdictional data, sales type, or the like. Because each UPID also identifies the jurisdiction, the release date can be tied to a particular game/cabinet combination in a particular jurisdiction. Accordingly, updates to a particular configuration may be made quickly at a network location, and propagated to other devices across a network based on the UPID. Gaming data from multiple locations can be aggregated based on a received or determined UPID.

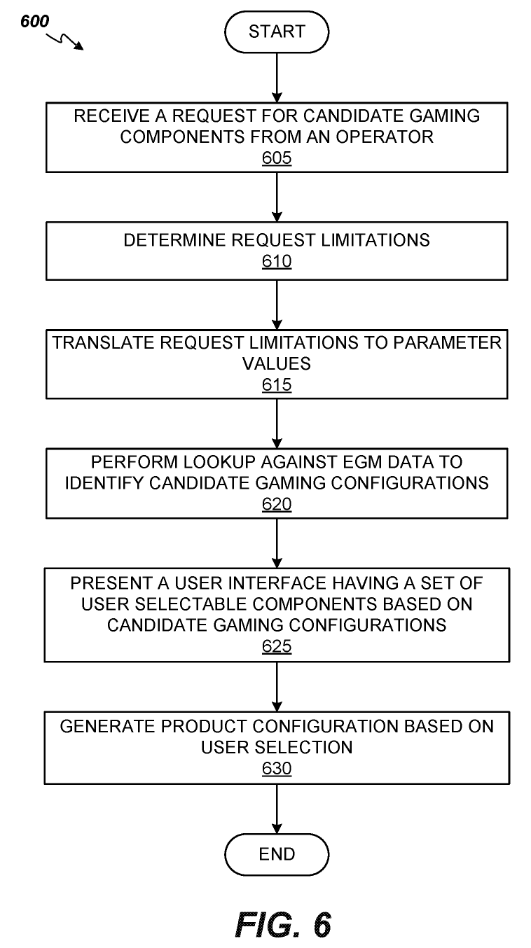

FIG. 6 is a flow chart of a technique for using UPIDs to access gaming configuration data, in accordance with one or more embodiments. The flowchart is depicted with a set of processes performed in a particular order. However, it should be understood that in certain embodiments, the various processes may be performed in a different order. Further, some processes presented in FIG. 6 may be omitted. The processes are described as being performed by particular components. However, in certain embodiments, the processes may be performed by alternative components.

The flowchart 600 begins at block 605, where a CMS receives a request for candidate gaming components from an operator device. The request may be input by the operator via an input device of an operator device. In some embodiments, the request may be a request for information about available gaming configurations for the requesting operator. The request may specify one or more limitations or preferences for the candidate gaming components, such as game title, game family, cabinet type, class type, commercial type, jurisdiction, availability, budget, floor plan, inventory, contract, or the like.

The flowchart 600 proceeds to block 610, where the CMS determines the request limitations based on the request. The limitations or preferences may be determined based on the request. For example, a device or location from which the request is received can be used to determine a jurisdictional limitation. As another example, operator limitations may be predefined, for example based on space, budget, game class limitations, or the like.

At block 615, the CMS translates the request limitations to parameter values corresponding to a UPID format. The parameter values may include one or more numeric or alphanumeric codes that correspond to limitations or preferences for game configurations. For example, returning to the example UPID system described above with respect to FIG. 5A, if the operator requests, or is limited to, candidate gaming components that are Class 3 Sales games available in Nevada, the request limitations may include a class identifier of 3, a type identifier of 2, and a jurisdiction identifier of 30.

The flowchart 600 proceeds to block 620, where the CMS performs a lookup against the EGM data to identify candidate gaming configurations based on the parameter values. The EGM data may include game data with UPID 555 stored in the CMS and/or obtained from a remote system, such as a game analytics system, casino management device, data collection system, or the like. The lookup may include performing one or more automated operations including searching, filtering, matching, and/or comparing the EGM data with the parameter values determined at block 615 to identify candidate gaming configurations that satisfy the request limitations. For example, returning to the example of FIG. 5A, UPIDs are available for 112-1-18-3-2-30, 134-2-18-3-2-30, and 164-2-18-3-2-30 each include candidate gaming components that are Class 3 Sales games available in Nevada, the request limitations may include a class identifier of 3, a type identifier of 2, and a jurisdiction identifier of 30. Thus, UPIDs 112-1-18-3-2-30, 134-2-18-3-2-30, and 164-2-18-3-2-30 may be considered candidate gaming configurations.

At block 625, a user interface is presented to an operator having a set of user selectable components based on the candidate gaming configurations. The user interface may be displayed on the display of the operator device. The CMS may cause the user interface to be presented. Additionally, or alternatively, the operator device may present the user interface in response to receiving the resulting UPIDs from the lookup function. The user selectable components may include graphical elements, such as icons, buttons, menus, lists, or sliders, that allow the operator to select one or more components of the candidate gaming configurations, such as game title, game family, cabinet type, class type, commercial type, or jurisdiction. The user selectable components may also include information or indicators, such as text, images, colors, or symbols, which show the availability, performance, or compatibility of the candidate gaming configurations.

The flowchart concludes at block 630, where the CMS generates a product configuration based on the user selection. The product configuration may include one or more components of the candidate gaming configurations that are selected by the operator via the user selectable components. The product configuration may be associated with a UPID that corresponds to the selected components. For example, if the operator selects Game A and Cabinet A, the product configuration may include Game A, Cabinet A, and the UPID of 112-1-18-3-2-30. In some embodiments, the UPID may be used by the operator for additional functionality, such as initiating an order for additional games and/or cabinets.

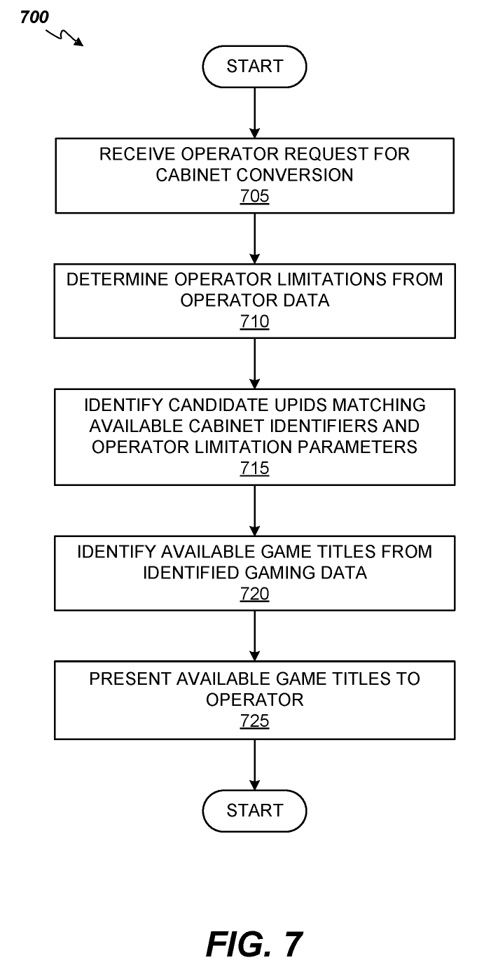

According to one or more embodiments, the UPIDs may be used to facilitate determining how to change a preexisting configuration for an operator. FIG. 7 is a flow chart of a conversion process according to one or more embodiments of the disclosure. The flowchart is depicted with a set of processes performed in a particular order. However, it should be understood that in certain embodiments, the various processes may be performed in a different order. Further, some processes presented in FIG. 7 may be omitted. The processes are described as being performed by particular components. However, in certain embodiments, the processes may be performed by alternative components.

The flowchart 700 begins at block 705, where the CMS receives an operator request for cabinet conversion. The request may be input by the operator via an operator device. The request may specify a cabinet type or a cabinet identifier for which the operator wants to convert the game software. In some embodiments, the operator device may include an EGM management application that provides an interface to the operator depicting current game configurations at a particular location for the operator. In some embodiments, the EGM management application may provide a user interface in which the operator may select a cabinet or game configuration known to be at the particular gaming location, for example from operator data. Alternatively, candidate cabinets may be identified by the CMS. The operator available cabinets may include one or more cabinet types or cabinet identifiers that the operator currently has on the casino floor.

The flowchart 700 proceeds to block 710, where the CMS determines the operator limitations from the operator data. The operator limitations may include one or more parameters or values that restrict the conversion options for the operator, such as class type, commercial type, jurisdiction, budget, or contract. In some embodiments, the operator limitations may also include operator preferences or other data predefined by the operator data. In some embodiments, the operator limitations may be determined from one or more additional sources. For example, a gaming location may be derived from metadata indicating a source of the request. As another example, the CMS may access local operator data that identifies operator limitations and/or preferences.

At block 715, the CMS identifies gaming data with UPIDS matching the available cabinet identifiers and the operator limitation parameters. The UPIDs may be identified from CMS storage, and/or may be obtained from a game analytics system or other system communicably coupled to the CMS. The matching process may include an automated process for searching, filtering, matching, or comparing the gaming data with UPID with the available cabinet identifiers and the operator limitation parameters to identify gaming data with UPID that satisfy the operator available cabinets and the operator limitations. For example, if the operator available cabinets include Cabinet A and Cabinet B, the corresponding cabinet identifiers can be determined and used along with other operator limitations. Returning to the example of FIG. 5A, if the operator limitations include Class 3 games, the matching may identify UPID records that have a cabinet identifier of 18 or 21, a class identifier of 3, and a jurisdiction identifier of 30, such as 112-1-18-3-2-30 and 134-2-18-3-2-30.

The flowchart 700 proceeds to block 720, where the CMS identifies available game titles from the identified gaming data with identified UPIDs. The available game titles may include one or more game titles or game title identifiers that correspond to the identified gaming data with UPIDs. The identification may include parsing, extracting, or decoding the game title identifiers from the UPID of the identified gaming data with UPID. For example, if the identified gaming data with UPID include 112-1-18-3-2-30 and 134-2-18-3-2-30, the identification may include translating the title identifiers 112 and 134 and the cabinet identifiers 1 and 2 to determine that Cabinet A can be converted to host Game A, and Cabinet B can be converted to host Game B.

The flowchart 700 concludes at block 725, where the CMS presents the available game titles to the operator. The presentation may include displaying the available game titles on a display of the operator device, along with the cabinet to be converted. The presentation may also include providing information or indicators, such as text, images, colors, or symbols, which show the availability, performance, or compatibility of the available game titles. For example, the presentation may show the game names, game features, game assets, game release dates, game performance data, and game conversion options for each game title. In some embodiments, the CMS may initiate conversion of the cabinet upon selection by the operator. For example, the CMS may automatically initiate conversion by transmitting the game package for the selected game title to the cabinet. Alternatively, a work order or other notification can be automatically generated and transmitted to a remote device to cause the selected cabinet to be converted to host the selected game title.

According to some embodiments, UPIDs and corresponding records of gaming data may be created and/or managed from one or more remote sources. Thus, occasionally the CMS may receive updated gaming data, from which local gaming data can be updated. FIG. 8 depicts a flowchart of a technique for updating CMS gaming data, according to one or more embodiments of the disclosure. The flowchart is depicted with a set of processes performed in a particular order. However, it should be understood that in certain embodiments, the various processes may be performed in a different order. Further, some processes presented in FIG. 8 may be omitted. The processes are described as being performed by particular components. However, in certain embodiments, the processes may be performed by alternative components.

The flowchart 800 begins at block 805, where the CMS obtains updated game data from a remote source, such as the game analytics system. The updated game configuration data may include a set of records associated with UPIDs, where the game data has been changed, added, or deleted. For example, data for a particular game configuration may be revised. Alternatively, new records may be added with new UPIDs. In some embodiments, the updated game data may be received as a JSON file or other file type.

The flowchart 800 proceeds to block 810, where the CMS compares the UPID for each record from the updated game configuration data to locally stored UPIDs. The locally stored UPIDs may include UPIDs that are stored in the CMS and associated with game data with UPID. The comparison may include searching, filtering, matching, or comparing the UPID for each record from the updated game configuration data with the locally stored UPIDs to determine whether the UPID for each record from the updated game configuration data matches or does not match any of the locally stored UPIDs.

As part of comparing the UPIDs for each record, the flowchart 800 includes, at block 815, determining whether the UPID for each record from the updated game configuration data matches any of the locally stored UPIDs. In some embodiments, the matching process may be performed in a hierarchical manner. For example, in some embodiments, the matching process may begin by parsing the UPID and determining whether a title identifier for a UPID in the updated data set matches a preexisting title identifier. If so, then a family identifier for the UPID in the updated data set matches a preexisting family identifier from the matches determined from the title identifier. If so, then a cabinet identifier for the UPID in the updated data set matches a preexisting cabinet identifier from the matches determine from the title identifier and the family identifier. The checking process may continue to be performed for at least a subset of the parameters of the UPID in a predefined hierarchical manner.

If a determination is made at block 815 that the UPID does match a preexisting UPID, then the flowchart concludes at block 830, and the associated gaming data corresponding to the matched UPID is updated in the local data store based on the received updated gaming data. However, returning to block 815, if a determination is made that the UPID does not match a preexisting UPID, then the flowchart 800 proceeds to block 820. At block 820, the CMS creates a new asset in the EGM data store for the record from the updated game configuration data. The new asset may include a new game data with the unmatched UPID that corresponds to the record from the updated game configuration data. According to some embodiments, the new asset may be created by branching a preexisting asset based on the hierarchical tier from which a determination was made that no match was found. The flowchart 800 concludes at block 825, where the CMS appends the game data for the record from the updated game configuration data to a record for the UPID based on the newly created asset.

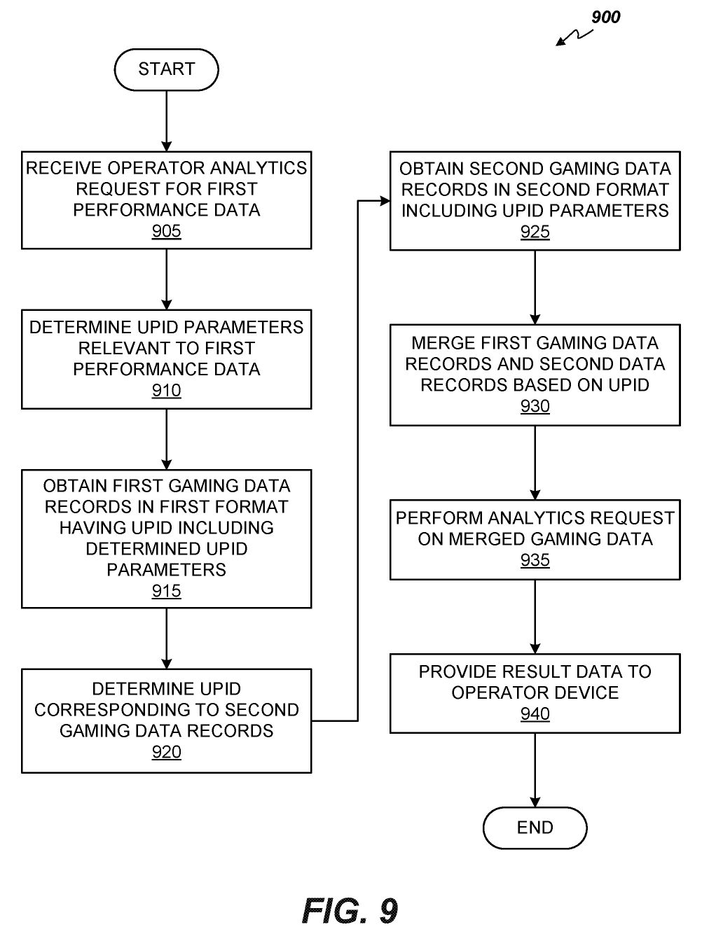

The use of UPIDs to identify game configurations allows for enhanced analytics by merging gaming data across multiple devices in different formats. FIG. 9 depicts a flowchart of a process for merging analytic data according to one or more embodiments of the disclosure. The flowchart is depicted with a set of processes performed in a particular order. However, it should be understood that in certain embodiments, the various processes may be performed in a different order. Further, some processes presented in FIG. 9 may be omitted. The processes are described as being performed by particular components. However, in certain embodiments, the processes may be performed by alternative components.

The flowchart 900 begins at block 905, where the CMS receives an operator analytics request for first performance data. The request may be input by the operator via an operator device. The request may specify one or more parameters or values for the first performance data, such as game title, game family, cabinet type, class type, commercial type, jurisdiction, or availability. In some embodiments, the operator device may provide an interface for selection of parameters for analysis, such as a particular game, family, cabinet, or some combination thereof. The operator device may provide selectable options, for example, based on operator data corresponding to gaming devices in the gaming location associated with the operator.

The flowchart 900 proceeds to block 910, where the CMS determines the UPID parameters relevant to the first performance data. The UPID parameters may include one or more numeric or alphanumeric codes that correspond to the parameters or values specified by the operator that are encoded in UPID values. For example, a particular cabinet identifier or game title identifier may be determined from a predefined mapping. The relevant parameters may be based on the request, and/or may be inferred or determined for locally stored operator data, metadata from the analytics request, or the like.

At block 915, the CMS obtains first gaming data records in a first format, where the records are identified by a UPID, and where the records include the determined relevant UPID parameters. The first gaming data records may include game data with UPID stored in the CMS and/or obtained from another device or system, such as the game analytics system, the casino management system, and/or the data collection system.

The flowchart 900 proceeds to block 920, the CMS determines the UPID corresponding to the second gaming data records. The second gaming data records may include game data stored in a different format in a different system, and may not be associated with a UPID. Thus, the CMS may determine, based on other identifiers for game, cabinet, or jurisdictional characteristics, the corresponding UPID parameter values. At block 925, the CMS may then assign a UPID based on the parameter values. Accordingly, the configurations for the second gaming data is identified with a common format as the first gaming data.

At block 930, the CMS merges the first gaming data records and the second data records based on the UPID. The merging may include combining, linking, or integrating the first gaming data records and the second data records based on the UPID to create a unified set of gaming data records. Then, at block 935, the CMS performs an analytics request on the merged gaming data. The analytics request may include analyzing, processing, or evaluating the merged gaming data to generate performance data, such as game revenue, game utilization, game popularity, and game player demographics. The analytics request can parse the data for more specific analysis on particular games, families, cabinets, jurisdictions, or the like, by using gaming data with UPIDs having the relevant UPID parameters, as determined at block 910. The flowchart 900 concludes at block 940, where the CMS provides the result data to the operator device.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A non-transitory computer readable medium comprising computer readable code executable by one or more processors to:
receive, from an operator device associated with an operator, a request for candidate gaming components for preexisting gaming machines associated with the operator, wherein the request indicates a gaming device characteristic for one or more of the preexisting gaming machines;
determine, based on the request, one or more candidate gaming component limitations, wherein the one or more candidate gaming component limitations comprises the gaming device characteristic;
determine a first configuration value for a first configuration parameter associated with the gaming device characteristic;
identify a plurality of available gaming device configurations from a data structure comprising a global set of gaming device configurations each defined by a unique configuration identifier having a predefined format comprised of a series of configuration parameters comprising the first configuration parameter, wherein the plurality of available gaming device configurations are identified based on having a corresponding configuration identifier having the first configuration value for the first configuration parameter;
determine the candidate gaming components from the plurality of available gaming device configurations; and
transmit an indication of the candidate gaming components to the operator device.

2. The computer readable medium of claim 1, wherein the candidate gaming components are presented on a user interface of the operator device, and further comprising computer readable code to:
receive a selection of one or more of the candidate gaming components from the operator device;
determine a second configuration value for a second configuration parameter associated with the selected one or more candidate gaming components;
determine a particular configuration identifier having the second configuration value for the second configuration parameter; and
perform a lookup for gaming data associated with the particular configuration identifier; and
provide the gaming data to the operator device.

3. The non-transitory computer readable medium of claim 1, wherein at least one of the one or more candidate gaming component limitations is based on the operator from which the request is received.

4. The non-transitory computer readable medium of claim 3, further comprising computer readable code to:
determine a second configuration value for a second configuration parameter associated with a jurisdictional characteristic,
wherein the plurality of available gaming device configurations are further identified based on having the second configuration value for the second configuration parameter.

5. The non-transitory computer readable medium of claim 1, wherein the request for gaming data comprises a request to transition a preexisting cabinet at a gaming location associated with the operator, and wherein the one or more first configuration parameters comprise an identifier for the preexisting cabinet.

6. The non-transitory computer readable medium of claim 5, wherein the request for candidate gaming components comprises a request for available gaming titles, and wherein the computer readable code to determine the candidate gaming components from the plurality of available gaming device configurations comprises computer readable code to:
identify, for a second configuration parameter associated with gaming titles, a set of title configuration values;
translate the set of title configuration values to a set of titles; and
transmit the set of titles to the operator device.

7. The non-transitory computer readable medium of claim 1, wherein the predefined format comprises a concatenation of numerical values each corresponding to one of the series of configuration parameters.

8. A method comprising:
receiving, from an operator device associated with an operator, a request for candidate gaming components for preexisting gaming machines associated with the operator, wherein the request indicates a gaming device characteristic for one or more of the preexisting gaming machines;
determining, based on the request, one or more candidate gaming component limitations, wherein the one or more candidate gaming component limitations comprises the gaming device characteristic;
determining a first configuration value for a first configuration parameter associated with the gaming device characteristic;
identifying a plurality of available gaming device configurations from a data structure comprising a global set of gaming device configurations each defined by a unique configuration identifier having a predefined format comprised of a series of configuration parameters comprising the first configuration parameter, wherein the plurality of available gaming device configurations are identified based on having a corresponding configuration identifier having the first configuration value for the first configuration parameter;
determining the candidate gaming components from the plurality of available gaming device configurations; and
transmitting an indication of the candidate gaming components to the operator device.

9. The method of claim 8, wherein the candidate gaming components are presented on a user interface of the operator device, and further comprising:
receiving a selection of one or more of the candidate gaming components from the operator device;
determining a second configuration value for a second configuration parameter associated with the selected one or more candidate gaming components;
determining a particular configuration identifier having the second configuration value for the second configuration parameter; and
performing a lookup for gaming data associated with the particular configuration identifier; and
providing the gaming data to the operator device.

10. The method of claim 8, wherein at least one of the one or more candidate gaming component limitations is based on the operator from which the request is received.

11. The method of claim 10, further comprising:
determining a second configuration value for a second configuration parameter associated with a jurisdictional characteristic,
wherein the plurality of available gaming device configurations are further identified based on having the second configuration value for the second configuration parameter.

12. The method of claim 8, wherein the request for gaming data comprises a request to transition a preexisting cabinet at a gaming location associated with the operator, and wherein the one or more first configuration parameters comprise an identifier for the preexisting cabinet.

13. The method of claim 12, wherein the request for candidate gaming components comprises a request for available gaming titles, and wherein determining the candidate gaming components from the plurality of available gaming device configurations comprises:
identifying, for a second configuration parameter associated with gaming titles, a set of title configuration values;
translating the set of title configuration values to a set of titles; and
transmitting the set of titles to the operator device.

14. The method of claim 8, wherein the predefined format comprises a concatenation of numerical values each corresponding to one of the series of configuration parameters.

15. A system comprising:
one or more processors; and
one or more computer readable media comprising computer readable code executable by the one or more processors to:
receive, from an operator device associated with an operator, a request for candidate gaming components for preexisting gaming machines associated with the operator, wherein the request indicates a gaming device characteristic for one or more of the preexisting gaming machines;
determine, based on the request, one or more candidate gaming component limitations, wherein the one or more candidate gaming component limitations comprises the gaming device characteristic;
determine a first configuration value for a first configuration parameter associated with the gaming device characteristic;
identify a plurality of available gaming device configurations from a data structure comprising a global set of gaming device configurations each defined by a unique configuration identifier having a predefined format comprised of a series of configuration parameters comprising the first configuration parameter, wherein the plurality of available gaming device configurations are identified based on having a corresponding configuration identifier having the first configuration value for the first configuration parameter;
determine the candidate gaming components from the plurality of available gaming device configurations; and
transmit an indication of the candidate gaming components to the operator device.

16. The system of claim 15, wherein the candidate gaming components are presented on a user interface of the operator device, and further comprising computer readable code to:
receive a selection of one or more of the candidate gaming components from the operator device;
determine a second configuration value for a second configuration parameter associated with the selected one or more candidate gaming components;
determine a particular configuration identifier having the second configuration value for the second configuration parameter; and
perform a lookup for gaming data associated with the particular configuration identifier; and
provide the gaming data to the operator device.

17. The system of claim 15, wherein at least one of the one or more candidate gaming component limitations is based on the operator from which the request is received.

18. The system of claim 17, further comprising computer readable code to:
determine a second configuration value for a second configuration parameter associated with a jurisdictional characteristic,
wherein the plurality of available gaming device configurations are further identified based on having the second configuration value for the second configuration parameter.

19. The system of claim 15, wherein the request for gaming data comprises a request to transition a preexisting cabinet at a gaming location associated with the operator, and wherein the one or more first configuration parameters comprise an identifier for the preexisting cabinet.

20. The system of claim 19, wherein the request for candidate gaming components comprises a request for available gaming titles, and wherein the computer readable code to determine the candidate gaming components from the plurality of available gaming device configurations comprises computer readable code to:
identify, for a second configuration parameter associated with gaming titles, a set of title configuration values;
translate the set of title configuration values to a set of titles; and
transmit the set of titles to the operator device.
